(19) United States
(12) Patent Application Publication
(10) Pub. No.: US 2008/0244516 A1
(43) Pub. Date: Oct. 2, 2008

(54) VARIABLE CAPTURE IN OBJECT ORIENTED LANGUAGES

(75) Inventors: Henricus Johannes Maria Meijer, Mercer Island, WA (US); Amanda Silver, Seattle, WA (US); Paul A. Vick, Seattle, WA (US); Harish Kantamneni, Redmond, WA (US); Jared Parsons, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/829,072

(22) Filed: Jul. 26, 2007

Related U.S. Application Data
(60) Provisional application No. 60/908,091, filed on Mar. 26, 2007.

(51) Int. Cl. G06F 9/44

(52) U.S. Cl. 717/116

(57) ABSTRACT

Systems and methods facilitate variable capture with respect to closures in object oriented programming languages. In particular, multiple copies of closure variables are generated such that lifetime of variables is defined by variable scope. However, if a previous version of a variable exists, a newly created variable is initialized with the value of the previous version.

### CROSS-REFERENCE TO RELATED APPLICATION(S)

This application claims the benefit of U.S. Provisional Patent Application Ser. No. 60/908,091 filed on Mar. 26, 2007, entitled “VARIABLE CAPTURE IN OBJECT ORIENTED LANGUAGES.” The entirety of this application is incorporated herein by reference.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implement code utilizing an object-oriented programming language (e.g., Visual Basic, C#, Java . . . In accordance with such a paradigm, programmers will create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

Programs can include a plurality of different programmatic concepts or features. One programmatic feature that is gaining popularity is closure. A closure is a function that captures environmental elements such as variables. A closure often occurs with respect to nested functions or methods. For example, where an inner function refers to variables that are defined in an outer function a closure can be employed to facilitate execution.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to variable capture systems and methods. More specifically, the disclosure concerns capture of variables for closures, among other things. Variables are captured such that their lifetime is equal to the scope in which they are declared. However, when creating a new variable for capture, if a previous version of that variable exists, the value of the previous version can be copied into the newly created variable.

In accordance with an aspect of the disclosure, a variable capture system is provided. The system identifies programming situations involving closures (e.g., local variable called from a nested loop function). Multiple copies of a variable are generated as needed. Each copy is provided with the value of a previously generated copy, if one exists. Accordingly, each calling function is provided with a unique copy of the local variable.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a variable capture system in accordance with an aspect of the disclosed subject matter.

FIG. 2 is a block diagram of a representative variable capture component.

FIG. 3 is a block diagram of a representative initialization component.

FIG. 4 is a block diagram of a program development system that employs disclosed aspects.

FIG. 5 is a block diagram of an exemplary user interface of a program development system that employs disclosed aspects.

FIG. 6 is a flow chart diagram of a method of variable capture in accordance with an aspect of the subject disclosure.

FIG. 7 is a flow chart diagram of a method of variable capture in accordance with an aspect of the subject disclosure.

FIG. 8 is a flow chart diagram of a method of affording programmatic assistance in accordance with an aspect of the claimed subject matter.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and methods are provided hereinafter related to variable capture, for instance for closures. Variables are captured via generation of a new copy for a particular variable scope such that scope and lifetime are the same and initialization of the variable copy with a previous incarnation, where applicable. This is a hybrid mechanism that avoids side effects or unintended results associated with variable sharing and solely allocating new variables for a scope. Furthermore, a development system disclosed that identifies variables for presentation to a user as a function of scope rather than lifetime.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

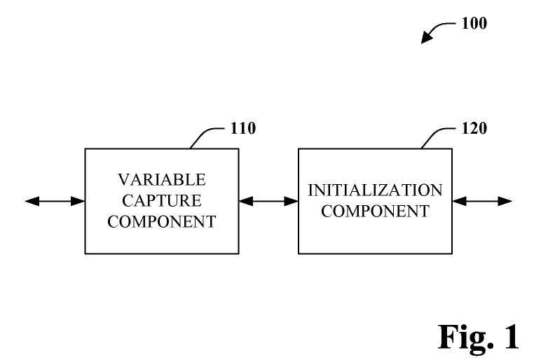

Referring initially to FIG. 1, a variable capture system 100 is depicted in accordance with an aspect of the claimed subject matter. A variable is a programmatic element that identifies a volatile quantity or expression stored in memory. Variables are associated with two different but related properties—scope and lifetime. Scope pertains to where a variable's name can be used in a program. Lifetime relates to how long in a variable is stored in memory. In most programming languages, the scope of a local variable is at least a subset of the lifetime of the variable. This is understandable since, for example, if the scope of a variable extends beyond the lifetime of the variable, the variable could be referred to after the storage of the variable goes away.

In accordance with an aspect, variables can be captured with respect to closures. A closure is a programmatic construct that captures variables declared or defined in an outer scope. Examples of closures include, without limitation, anonymous or inner functions, where a function is defined inside another function or a function defined within a method. That inner function can refer to variables that are defined in the outer scope. Another example is classes defined within another class where the inner class refers to instance fields of an outer class. More particularly, a programming language's term is referred to as open if it has free variables that are not bound to a value. A term is closed if it has no free variables. Accordingly, a closure “closes” a term by binding a value to a term. For example, if a nested function (e.g., a function declared within another function) makes reference to a variable declared in the outer function, the variable would be open without closures. The variable is not bound to a value within the scope of the nested function. However, a closure enables the nested function to make reference to the variable as if it were closed by binding the value of the variable in the outer scope.

A problem exists with respect to how to deal with the lifetime of variables that are captured in a closure. A variety of approaches can be employed. By way of example consider the following code snippet:

```
Module Module1
    Sub Main( )
        For i As Integer = 0 To 2
            Dim x as Integer
            Console.WriteLine(x)
            x += 1
        Next
        Console.ReadLine( )
    End Sub
End Module
```

The above code snippet prints “0, 1, 2,” because the lifetime of a local variable does not equal its scope. If the lifetime of variable x is the same as its scope, than the storage for x would be released at the end of the “For . . . Next” loop statement block and the snippet would print “0, 0, 0.” In fact, in the code snippet as well as in some programming languages, the lifetime of a local variable is from the beginning of a method all the way through to the end of a method, regardless of a variable's scope. Accordingly, even though x is only in scope within the “For . . . Next” loop statement block, it lives throughout the entire method. Thus, the same storage location for the variable x is accessed each time through the loop, thereby printing “0, 1, 2.” However, without closures, there is no real way to observe when a variable actually gets instantiated.

Consider the following example that involves a closure:

```
Sub Main( )
    Dim value As Integer
    Dim xs = {1, 2, 3, 4}
    value = 2
    Dim ys = From x In xs Where x < value Select x
    For Each y As Integer In ys
        Console.WriteLine(y)
    Next
    Console.ReadLine( )
End Sub
```

Behind the scenes, the implementation of this query utilizes closures/anonymous functions. As previously mentioned, a closure is a special structure that lives outside of the method that includes the local variables that need to be referred to by others methods. When a query refers to a local variable (or parameter), that variable is captured by a closure and all references to the variable are redirected to the closure. So the statement “value=2” assigns the value 2 to a variable location in a closure not a variable location on a stack. Since the closure lives outside the method, methods created by a language integrated query (LINQ), such as the anonymous function utilized to implement the above example, can legally refer to the local variables captured in the closure, and code performs as expected.

Now consider a similar scenario where queries are created inside a loop:

```
Module Module1
  Sub Main( )
    Dim queries(2) As IEnumerable(Of Integer)
    Dim xs = { −2, −1, 0, 1, 2 }
    For i As Integer = 0 To 2
      Dim y As Integer = i
      queries(i) = From x In xs Where x <= y Select x
    Next
    For Each q As Integer In queries(0)
      Console.WriteLine(q)
    Next
    Console.ReadLine( )
  End Sub
End Module
```

The intent of this code is to create an array of queries that have different upper bounds for which to query a target object (e.g., array xs). The array of queries is populated in a “For . . . Next” loop statement block so that individual queries are provided with different upper bounds from “0” to “2” to apply to the target object. In particular, “queries(2)” will return all values less than or equal to “2,” “queries(1)” will return all values less than or equal to “1,” and “queries(0)” will return all values less than or equal to zero. Accordingly, the intended result of the code is “−2 −1 0.”

However, the lifetime of variable “y” is the entire method. Each iteration of the loop does not get its own copy of variable “y,” but rather receives a reference to the same storage location for “y” that every other iteration receives. Thus, when a query captures the local variable “y” in one iteration of the loop, the query captures a reference to the same storage location of the variable “y” that other queries capture in other iterations of the loop. Accordingly, when the variable y is changed inside of the loop by assigning the value of iterating variable “i,” the new value is stored in the single storage location for variable “y” referenced by all queries. Thus, given the straightforward semantics where the lifetime of a variable starts at the beginning of the method, the result is “−2 −1 0 1 2.” In other words, all of the queries are going to return the same set of values. In this case, so that the results match the intended results, each iteration of the loop can capture a unique copy of “y” to provide the queries with different upper bounds. In other words, variable “y” should be treated as if its lifetime was only the inner part of the loop, not the whole method.

Another example that illustrates a problem with variable lifetimes and closures is given by the following code fragment:

```
Module Module1
  Delegate Function AddDelegate(ByVal x As Integer) As Integer
  Sub Main( )
    Dim lambdas(9) As AddDelegate
    For i As Integer = 0 To 9
      Dim y As Integer = i
      lambdas(i) = Function(x) x + y
    Next
    For Each l As AddDelegate In lambdas
      Console.WriteLine(l(0))
    Next
    Console.ReadLine( )
  End Sub
End Module
```

This code fills an array with lambda expressions that are supposed to add a particular value to the parameter. Specifically, each lambda expression receives a parameter “x” and returns the sum of parameter “x” and the value of variable “y.” For example, “lambdas(0)” will add “0” to the parameter, “lambdas(1)” will add “1” to the parameter, etc. At least, that is the intent. Each lambda expression is defined with a reference to variable “y” that is declared within a “For . . . Next” loop block. Thus, a question exists as to whether each iteration of the “For . . . Next” loop should receive a unique copy of the local variable “y” or should all iterations share the same copy of the variable.

For example, if each iteration receives the same copy of variable “y,” the code would behave similar to the previous example and not as intended. More specifically, “lambdas(0)” would output the same result as “lambdas(9)” as both expressions captured the same copy of variable “y” that is repeatedly altered during the loop until reaching a final value of “9.” Accordingly, all lambda expression in the array add “9” to parameter “x.” However, if each iteration receives a unique copy of variable “y,” the above code would behave as intended. The lifetime of variable “y” would be the same as its scope. Each lambda expression captures a different copy of variable “y” with a different storage location and, accordingly, a different value. Thus, “lambdas(0)” will add “0” to the parameter as intended, “lambdas(1)” will add “1” to the parameter, etc. Therefore, in the case of the above example, it is desirable for each iteration to receive a unique copy of variable “y.”

Here is a slightly different, but equally valid, way to write the same code:

```
Module Module1
  Delegate Function AddDelegate(ByVal x As Integer) As Integer
  Sub Main( )
    Dim lambdas(9) As AddDelegate
    For i As Integer = 0 To 9
      Dim y As Integer
      lambdas(i) = Function(x) x + y
      y += 1
    Next
    For Each l As AddDelegate In lambdas
      Console.WriteLine(l(0))
    Next
    Console.ReadLine( )
  End Sub
End Module
```

Now instead of initializing variable y at the beginning of each iteration of the loop with the value of variable “i,” variable “y” is simply incremented and the value is carried over from one iteration of the loop to another. However, this code will not behave the same as the previous example written in a different way. In the previous example, it was desirable for each iteration to receive a unique copy of local variable “y” so that the intended result occurs. However, if each iteration of the loop gets its own copy of variable “y,” then, in the current example, every lambda expression will add “0” to parameter “x.” Each lambda expression captures the unique copy of variable “y” provided to each iteration of the loop. Variable “y” is not explicitly initialized, it is provided with a value of “0” by default. Accordingly, all the lambda expressions capture a unique copy of variable “y” with a value of “0.” Thus, providing a unique copy of local variable “y” to each iteration of the loop conflicts with the notion that the value of variable “y” carries over from one iteration of the loop to another.

System 100 enables this conflict to be resolved. More particularly, system 100 can capture variables and treat the lifetime of variables to be the scope in which they are declared. Accordingly, if a closure is created in a loop, each iteration of the loop can get its own copy of the local variable. However, when creating a new variable copy, if a previous version of that variable exists, the value from that previous version can be provided to the newly created variable copy.

System 100 includes two components for providing such functionality, namely a variable capture component 110 and an initialization component 120. The variable capture component 110 captures local variables for closures. Each variable is captured such that it has a lifetime equal to the scope in which they are declared. Thus, in loop scenarios wherein a local variable is declared, a new copy of the local variable is created each time through the loop. The initialization component 120 initializes newly created variables by the variable capture component 110 with a value of a previous version of that same variable, if a previous version exists. If a previous version of the local variable does not exist (e.g., it is the first time through a loop), then the initialization component 120 provides a default value for the variable. For example, some programming languages specify a default value of “0” for variables declared as an integer type.

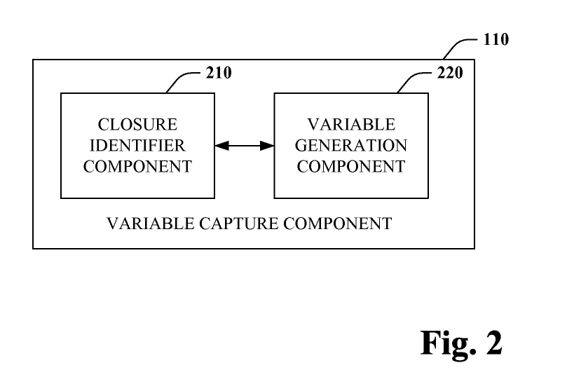

Referring now to FIG. 2, a representative variable capture component 110 is depicted in further detail. The variable capture component 110 includes a closure identifier component 210 and a variable generation component 220. The closure identifier component 210 identifies local variables in a closure wherein it is appropriate for such local variables to be treated as having lifetimes equal to scope in which the variables are declared. For example, the closure identifier component 210 can identify local variables declared within a loop structure wherein the local variables are captured in each iteration of the loop by an anonymous function, lambda expression, query or the like.

The variable generation component 220 creates new copies of the local variables identified by the closure identifier component 210. The variable generation component 220 creates as many copies as necessary. For example, in loop scenarios wherein a local variable is declared, a new copy is created for each iteration of the loop. The variable generation component 220 provides a new storage location for each newly created variable. Thus, each iteration of the loop receives a reference to a unique storage location of the local variable for its copy.

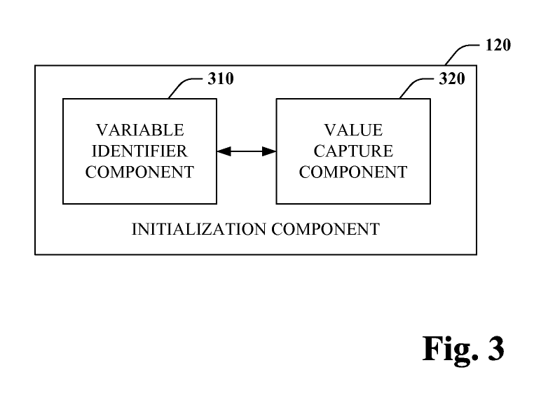

Turning to FIG. 3, the initialization component 120 is illustrated in further detail. As shown, the initialization component 120 includes a variable identifier component 310 and a value capture component 320. The variable identifier component 310 seeks to identify a preexisting variable associated with the new variable created by the variable capture component 110. For example, in a loop scenario wherein a local variable is declared, the preexisting variable could be the instance of the local variable for a previous iteration of the loop. The variable identifier component 310 identifies the preexisting variable as associated with the newly created copy of the local variable for a subsequent iteration of the loop.

The value capture component 320 captures the value of an identified preexisting variable to be utilized for initialization. For example, the value of the preexisting variable can be copied into the associated newly created variable. Accordingly, side effects are avoided because each iteration of the loop owns a unique version of the local variable. Further, the disparate copies of the local variable do not conflict with the notion that the value of local variable carries forward into a next iteration of the loop.

Although the above examples included solely “for loops,” it is to be appreciated that any other type of looping construct or statement block can take advantage of the aforementioned variable capture mechanisms. For instance, variables can be captured in a similar manner for “GOTO” statements, which provide for an unconditional transfer of control to another statement. In this situation, capture of variables can be triggered upon reentry of a block due to a “GOTO.” For example, a local variable should be captured and a new copy generated and initialized with a previous value when a looping structure is entered via a GOTO statement. Additionally, it should be appreciated that programming languages and/or situations involving closures may employ the aforementioned variable capture mechanisms.

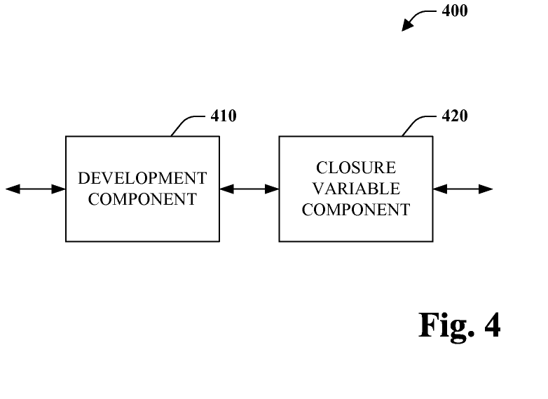

Although the above-described systems relate to language mechanisms, aspects of the disclosure can also apply to tooling, among other things. Referring to FIG. 4, a development system 400 is illustrated in accordance with an aspect of this disclosure. The development system 400 can include any one of a number of integrated development environments or the like. The system 400 includes a development component 410 and closure variable component 420. The development component 410 can correspond to any one of a number of development environment components and/or subcomponents including but not limited to a debugger. The closure variable component 420 facilitates injecting closure variables into development components 410, for example based on scope rather than lifetime. To elucidate further, a variable's lifetime may be an entire method while the variable's scope is a subset of the lifetime (e.g., a looping structure within the method). Accordingly, the variable persists at a storage location for the entire method but is only accessible inside the looping structure. The closure variable component 420 facilitates injecting closure variables into development 410 based on when variables are accessible (e.g., scope) rather than when variables persist (e.g., lifetime).

By way of example and not limitation, the development component 410 may be a debugger that includes several windows to present variables, among other things, at runtime. Some of those windows can capture and present variables as a function of a heuristic that identifies variables that might be of interest to a user. A possible heuristic, for example, would present what variables are being utilized at the present time. For example, these windows may present variables included in the current expression highlighted at a debugging breakpoint. In this situation, variables for closures can be added to these windows and/or heuristics adjusted as a function the variables' scope. Other windows present variables local to the current method or function. As with the heuristic-based watch windows, the windows that present variables local to the current method or function may be adjusted to present closure variables based on scope as opposed to lifetime. As discussed supra, a variable's lifetime can be an entire method. In accordance with the subject disclosure, wherein multiple copies of a local variable are generated, several copies of the same variable are local within the method. However, by presenting these variables based on scope rather than lifetime, the developer is shown the variable copies in scope and not the extraneous copies inaccessible at that time.

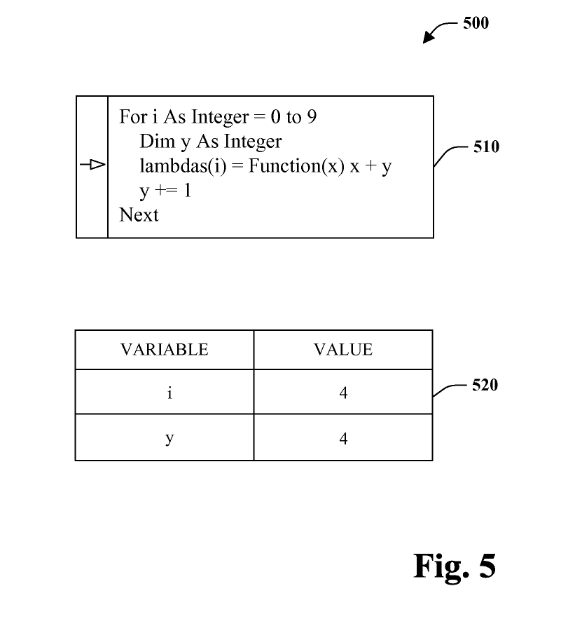

Turning briefly to FIG. 5, an exemplary user interface of a debugging development component 500 is depicted in accordance with an aspect of the disclosure. Debugger 500 includes a code watch window 510 and a variable watch window 520. The code watch window 510 enables a developer to examine the programming code currently subject to debugging. Further, the developer employs the code watch window 510 to set breakpoints in the execution of the code. A breakpoint halts execution of the code so that the developer may inspect the current runtime state, among other things.

The variable watch window 520 displays variables and values based on the current runtime state of the code at the breakpoint. The variable watch window 520 can be a heuristic-based window, a locals-based window, or the like. The variable watch window 520 displays closure variables based upon scope rather than lifetime. For example, consider the code snippet displayed by the code watch window 520. A looping structure is presented including lambdas expressions. Variable “y” is a closure variable. As discussed supra, the lifetime of variable “y” is the entire method despite the variable being declared within the looping structure. In accordance with an aspect of the subject disclosure, each iteration of the loop receives a unique copy of the closure variable “y.” However, instead of displaying all versions of variable “y” current persisting in storage locations, the variable watch window 520 presents only the version in scope. For example, the code in the code watch window involves a looping structure having ten iterations. During the fifth iteration, variable “i” will have a value of “4.” The variable watch window 520 presents the one copy of variable “y” in scope. That copy has a value of “4,” initialized from a previous version of variable “y.” The variable watch window 520 displays closure variables based on scope rather than lifetime and, thus, only presents one copy of variable “y” as opposed to all five current copies of variable “y.”

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the development component 410 can employ such mechanism to determine which and/or whether or not to present variables to a program during program development.

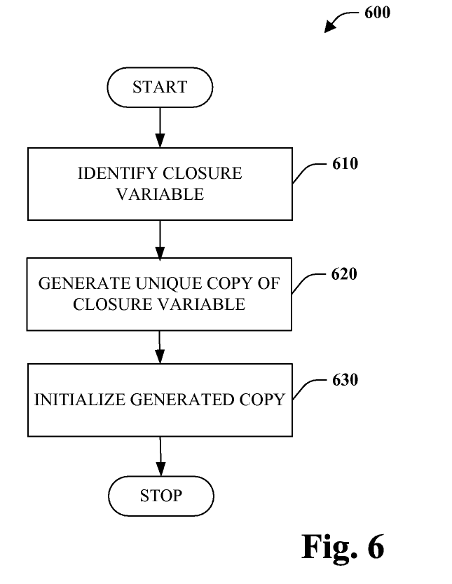

In view of the exemplary systems described supra, methodologies that may be implemented in accordance with the disclosed subject matter will be better appreciated with reference to the flow chart of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a flow chart diagram is provided that depicts a variable capture method 600 in accordance with an aspect of the disclosure. Among other things, the variable capture method 600 can be utilized to capture variables for closures. At reference numeral 610, variables captured by closures are identified. For example, a variable capture by a nested anonymous function or a query within a looping structure may involve a closure. At reference 620, a unique copy of the identified closure variable is generated. For example, a unique copy of a closure variable is generated for each iteration of a looping structure in which the closure variable is utilized. The unique copy is provided a new storage location. At reference 630, the unique copy generated is initialized to a value. For example, that value could be derived from a value of a previous version or copy of the closure variable in accordance with an aspect of the subject disclosure.

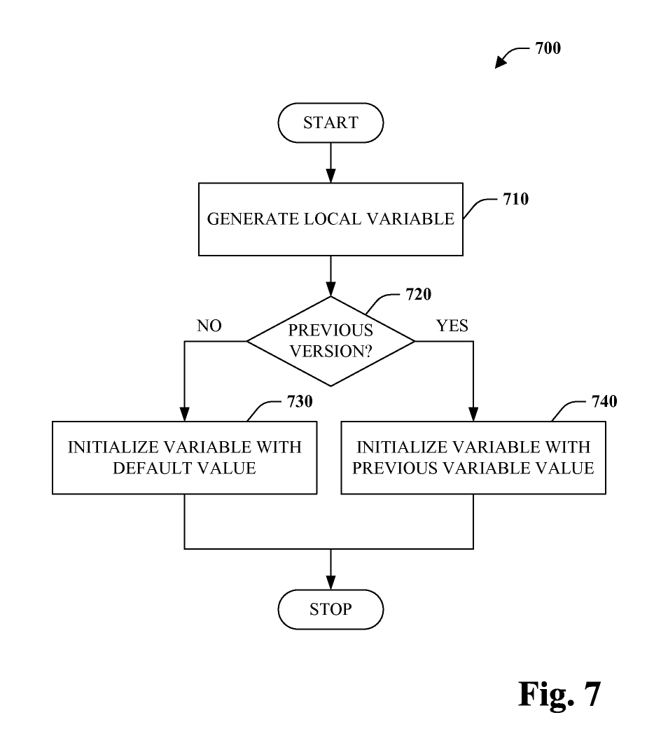

Referring to FIG. 7, a flow chart diagram is provided that depicts a variable initialization method 700 in accordance with an aspect of the disclosure. Variable initialization method 700 may be employed to initialize copies of captured closure variables, among other things. At reference numeral 710, a variable is generated for a local variable utilized within an inner block and defined within an outer block. At reference 720, a determination is made as to whether a previous version of the variable exists. Such can exist, for example, where the generated local variable is part of a loop structure. In such a situation, a previous version exists from pervious iterations of the loop structure. If no previous versions exist, the method simply the variable is initialized to a default value for a programming language and the method terminates at reference 730. If a previous version does exist, the method moves to reference 740 and the value of the previous version is copied into the generated variable thereby initializing it to the previous value. For example, a newly generated copy of a variable employed in a loop structure is initialized with the value of the previous copy utilized in the previous iteration of the loop structure.

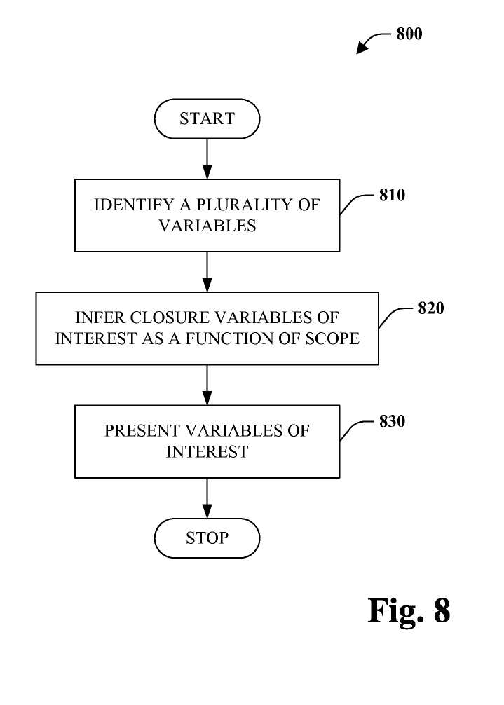

FIG. 8 is a flow chart diagram illustrating a method of affording programmatic assistance 800 in accordance with an aspect of the claimed subject matter. More specifically, the method 800 can related to development tools to assist development of programs. At reference numeral 810, a plurality of variables are identified for a given computer program. Such variables can be identified as a result of programmatic analysis of all or a portion of computer code. For example, in a debugging scenario code can be limited by designated breakpoints. At numeral 820, variables of interest for closures are inferred as a function of scope as opposed to lifetime, for instance. At reference numeral 830, variables of interest are presented to a user.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

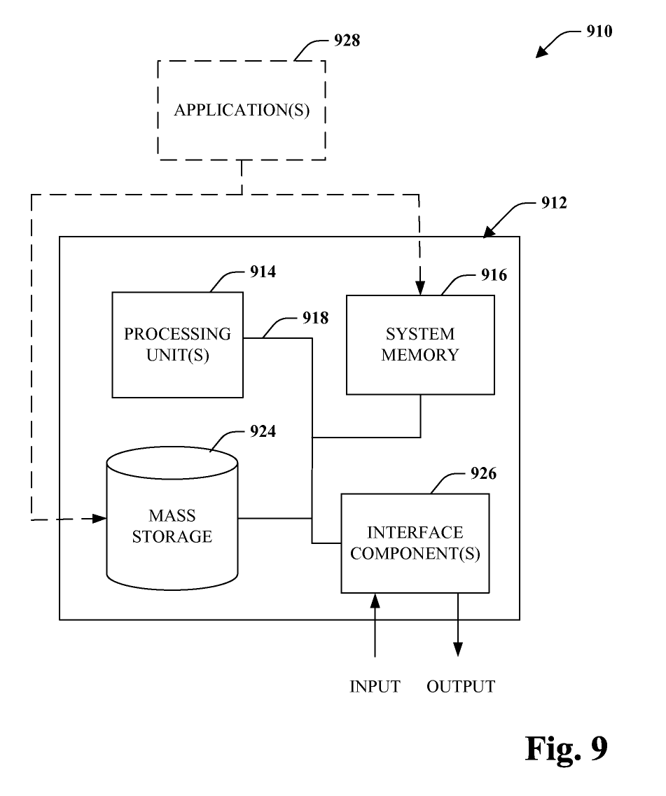

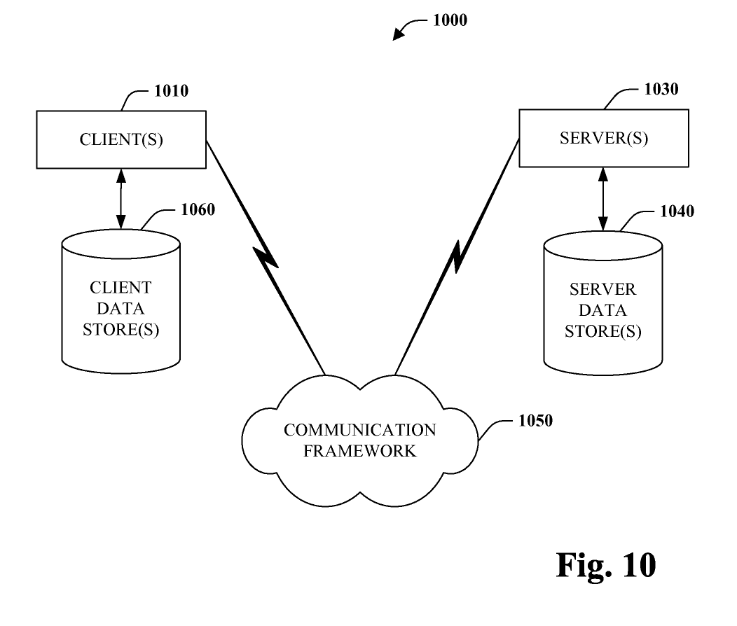

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system of variable capture, comprising:
a capture component that captures multiple copies of at least one local variable specified outside a calling structure; and
an initialization component that initializes a captured variable with a previously allocated incarnation of the variable in scope.

2. The system of claim 1, further comprising a closure identifier component that identifies the at least one local variable specified outside a calling structure.

3. The system of claim 2, further comprising a variable generation component that creates multiple copies of the at least one local variable identified by the closure identifier component.

4. The system of claim 3, the variable generation component allocates a new storage location for each of the multiple copies.

5. The system of claim 1, further comprising a variable identifier component that discovers an existence of the previously allocated incarnation of the variable in scope.

6. The system of claim 5, further comprising a value capture component that copies the value of a pre-existing previously allocated incarnation to the capture variable.

7. The system of claim 1, the calling structure is a loop.

8. The system of claim 7, the loop structure is a goto.

9. The system of claim 1, further comprising a closure variable component that injects variables into a development component based upon variable scope.

10. The system of claim 9, the development component is a debugger.

11. A method of variable capture, comprising identifying a local variable called by a nested loop function;
generating a new copy of the variable for each loop iteration; and
initializing the variable with a value of a previous version of the newly created variable, if a previous version of the variable exists.

12. The method of claim 11, further comprising binding a function variable to a generated copy.

13. The method of claim 11, generating a new copy comprises allocating a new storage location for the variable for each loop iteration.

14. The method of claim 13, initializing the variable comprises copying the value of the previous version from a storage location of the previous version to the newly allocated storage location of the variable.

15. The method of claim 11, initializing the variable further comprises providing a default value in the absence of a previous version of the variable.

16. The method of claim 11, further comprising presenting the variable to a development tool based on a scope of the variable.

17. The method of claim 16, further comprising inferring variables of interest for presentation as a function of variable scope rather than lifetime.

18. The method of claim 11, the local variable is declared outside a structure of the nested loop function.

19. A system for variable capture for a loop, comprising:
means for creating a copy of a local variable for each iteration of a loop function; and
means for initializing the variable with a value of a previously allocated manifestation of the variable in scope.

20. The system of claim 20, further comprising means for creating a copy of a local variable when the loop function is entered via a goto function.
